(19) United States
(12) Patent Application Publication
(10) Pub. No.: US 2012/0241685 A1
(43) Pub. Date: Sep. 27, 2012

(54) Method for adjusting the switching temperature of PTC ink composition and PTC ink composition

(75) Inventors: Kai Wu, Montreal (CA); Qingli Liu, Montreal (CA); Yali Yang, Montreal (CA); Steven Xiao, St. Laurent (CA)

(73) Assignee: CHEMSCITECH INC, ST-LARENT (CA)

(21) Appl. No.: 13/065,282

(22) Filed: Mar. 21, 2011

(51) Int. Cl. H01B 1/24; C09D 11/02

(52) U.S. Cl. 252/511

(57) ABSTRACT

The invention provides a method for producing a PTC ink composition, which is capable of adjusting the switching temperature (Ts) of the PTC ink composition by addition of some additives. The content of the additive based on the total PTC composition for adjusting the Ts is less than 5.0 wt. %. The additives for adjusting the Ts can be chosen from polyester, polyether, and poly(ethylene glycol) with low molecular weight from 300 to 3000 g/mol.

### REFERENCE CITED

U.S. PATENT DOCUMENTS

| | | |
|---|---|---|
| 4,628,187 A | December 1986 | Sekiguchi |
| 4,857,711 A | August 1989 | Watts |
| 5,198,639 A | March 1993 | Smuckler |
| 5,440,425 A | August 1995 | Kadooka |
| 5,714,096 A | February 1998 | Dorfman |
| 5,837,164 A | November 1998 | Zhao |
| 7,741,582 B2 | June 2010 | Howick et al. |

### TECHNICAL FIELD

The present invention relates to a method for producing a PTC ink composition, adjusting the switching temperature (Ts) of the PTC ink composition. More specifically, the present invention relates to a method for producing a PTC ink composition, the Ts of which is conveniently adjustable to meet different application requirements.

### BACKGROUND ART

A conductive polymeric composition exhibiting positive temperature coefficient (PTC) behavior and a device using the same have been used in many applications, especially in electronic industries, including their uses as constant temperature heaters, over current regulators, and low-power circuit protectors. A typical use is that the amount of the current passing through a circuit, which is controlled by the temperature of a PTC element forming part of the circuit.

The term “switching temperature” (Ts) is used to denote the temperature at which the PTC behavior occurs, i.e., a rapid increase in resistivity at a particular temperature or over a particular temperature range. For practical uses, different Ts are required to meet various applications. For example, the Ts of the PTC composition suitable for automotive mirror heaters is usually around 60° C., while for automotive seat heaters is around 90° C., as shown in U.S. Pat. Nos. 4,857,711, 5,198,639, 5,440,425, 5,714,096, and 7,741,582.

Basically, the Ts of most PTC compositions depend upon the properties of the polymer matrix such as its glass transition temperature (Tg), or melting point (Tm). That means the specific Ts is achieved by careful selection of polymer in order to obtain a useful PTC composition. For example, the PTC material containing a copolymer of polyethylene and vinyl acetate, as disclosed in U.S. Pat. No. 4,628,187 exhibits Ts of about 90° C. PTC compositions containing nylon 11 disclosed in U.S. Pat. No. 5,837,164 shows a Ts ranging from 140 to 200° C. However in practice, it is costly and time consuming to adjust the Ts by changing the polymeric resin used. First the change of polymeric resin in a PTC ink does not only amend the Ts but also needs to re-formulate solvents, fillers, additives and other ingredients involved in the original PTC composition, and indeed a complete new PTC ink needs to be re-formulated. Secondly, the polymer resin is used in the very first step of PTC ink processing, and the change of the polymer resin needs to completely re-processing the ink. A typical processing of PTC ink basically constitutes of the following steps in sequence: polymeric solution preparation, pre-mixing, grinding and letdown. As a consequence, changing a polymeric resin implies a complete new processing cycle. Therefore, it is extremely desirable to adjust the Ts without changing the polymer matrix and the conductive filler from the view of PTC ink compositions, and it is also extremely desirable to adjust the Ts in the final letdown step from the view of PTC ink processing. The present invention provides such a method to adjust the Ts, which not only largely reduces material and research costs but also offers the flexibility and advantage to amend the Ts of the already formulated PTC ink in the final step of processing.

### SUMMARY OF THE INVENTION

The present invention provides a PTC ink composition, which is screen printable and has a high PTC characteristic. The composition comprises, based on total composition, 10-40 wt. % of carbon black; 10-40 wt. % of functional polyolefin resin containing carbonyl groups, or ester groups, or maleic anhydride groups; 40-80% wt. % of organic medium capable of solubilizing the resin.

The present invention further provides a method to adjust the Ts of the PTC composition by addition of 0.5-5.0 wt. % (based on total composition) of additives to the final formulation. The additives are selected from polyester, polyether, and poly(ethylene glycol) with low molecular weight from 300 to 3000 g/mol.

The present invention further teaches how to process the PTC ink with adjustable Ts.

The present invention still further provides a sheet comprising a screen printing layer of the invented PTC ink composition from above which has been heated to remove volatile organic solvent.

### BRIEF DESCRIPTION OF THE DRAWINGS

FIG. 1 presents the plot of TCR (TCR: Temperature Coefficient Ratio is defined as the ratio between the resistivity at the given temperature and the resistivity at the 25° C.) versus temperature for Example 1 (triangles) and Example 2 (circles).

FIG. 2 presents the plot of TCR versus temperature for Example 3 (triangles) and Example 4 (circles).

### DETAILED DESCRIPTION OF THE INVENTION

Basically, a PTC ink formulation involves four parts (or components), and these four parts can be functionally classified as (1) the active component such as the electrically conductive fillers (metal particles or carbon); (2) the polymer component as the binder or adhesive; (3) the solvent used to mix all components together in a liquid or gel form and to enable the ink processing (printing or coating); (4) various additives to enhance the screen printing properties, surface properties of the printed film, and particularly to adjust the Ts of a PTC ink in the present invention.

The electrically conductive fillers in the present invention can be metallic particles, carbon black, graphite, and the like. The preferred filler is carbon black. The much preferable carbons for the present invention are these carbons having a low structure such as Cabot MONARCH 120 and REGAL 350R. The preferred content of the preferable low structure carbon comprises 10-50 wt. % of the total composition, with a most preferred range of 15-40 wt. %.

The preferred polymers of this invention are functional polyethylene and vinyl acetate, such as ®Vinnolit PA 5470/5 manufactured by Vinnolit GmbH & Co. KG Any chlorinated polyolefins containing carbonyl groups, or ester groups, or maleic anhydride groups may be used. In the composition of the present invention, the polymer is used in the range of 10-50 wt. % based on the total composition, with the most preferred range of 15-30 wt. %.

The selection of the solvent is based on its proper boiling point and the good solubility of polymer resin used. The polymer is completely dissolved in the organic vehicle prior to blending with other components. Any organic, inert liquid may be used as the solvent for the medium (vehicle) so long as the polymer is fully solubilized. The preferred solvents are selected from MEK, NMP, toluene, xylene, and the like. The most preferable solvent for this invention is dimethylnaphthalene.

In the present invention, specific Ts adjusting agent is added into the PTC ink formulation along with other optional dispersing additives and rheology additives. The Ts adjusting agent and other optional additives are used to adjust the Ts of the PTC ink, to increase the stability of the polymer in the vehicle, and to enhance the screen-printing properties. For examples, the dispersing additives such as BYK-220S and ANTI-TERRA-204 (BYK USA Inc.) can be preferably used. The rheology additives such as BYK-410 or BYK-430 can be preferably used. In the present invention, the preferable Ts adjusting agents are polyester, polyether, and poly(ethylene glycol). Still more preferable, these Ts adjusting agents are selected with low molecular weight (Mw) of 300 to 3000 g/mol. Still further preferable, the content of these Ts adjusting agents are used in the range of 1-10 wt. %, and most preferably in the range of 2-5 wt. %.

The invented PTC ink is preferably prepared according to the procedure consisting of the following steps. 1) The preparation of 10-30 wt. % polymer solution. For example, 80.0 grams of dimethylnaphthalene is firstly heated to 80° C. and then 20.0 grams of ®Vinnolit PA 5470/5 is added slowly into the system. The mixture is heated at 80° C. for 5 hours and yielding a light yellow homogenous solution. 2) The preparation of ink base. A dispersing additive 1.0-10.0 wt. % based on the total ink base is firstly added into the above polymer solution under mechanically stirring. Then, the carbon black 30-60 wt. % based on the total ink base is added slowly into the solution under mechanically stirring. This mixture is then subjected to a three-roll mill to assure proper dispersion of the carbon black to form a paste-like ink base. During the three-roll milling, a rheology additive 1.0-10.0 wt. % based on the total ink base may be added to enhance the screen-printing properties of the ink base. 3) The preparation of final PTC ink composition. The final PTC ink can be obtained by mechanically mixing the above polymer solution and ink base at certain ratios range from 0.5/1 to 1/1. The ratios depend on the needs of the application design such as the desired starting resistance. The switching temperature (Ts) of the PTC ink can now be adjusted in this step by addition of 0.5-5.0% additives such as PEG600 (Mₙ=600 g/mol, Aldrich).

The resulting PTC ink is applied to substrates such as polyester films (DuPont Teijin films) by the screen-printing process. After printing the PTC ink on a polyester film, it is cured in an oven at 120° C. for 5 minutes. Subsequently, a conductive paste suitable for use on polyester substrates such as DuPont 5025 silver paste is printed over edges of the PTC ink and cured at 120° C. for 5 minutes. The cured film is tested for resistance change with temperature. The resistance of the cured PTC film is measured as a function of temperature so the PTC characteristics and the Ts are determined.

### EXAMPLES

The invention will now be described in more detail with reference to the following examples. However, it should be understood that these examples are given for the purpose of illustration only and are not intended to limit the scope of the present invention.

Compositions for the Examples below are summarized in TABLE 1, where all component concentrations are expressed as percentage by weight based on the total ink composition.

TABLE 1

| | | | | Dispers- | | Ts |
|---|---|---|---|---|---|---|
| | | Carbon | | ing | Rheology | adjusting |
| | Polymer | black | Solvent | additive | additive | additive |
| Examples | (wt. %) | (wt. %) | (wt. %) | (wt. %) | (wt. %) | (wt. %) |
| Example 1 | 18.0 | 22.0 | 56.0 | 1.00 | 3.00 | 0 |
| Example 2 | 17.8 | 21.8 | 55.4 | 0.99 | 2.97 | 1.00 |
| Example 3 | 19.0 | 20.0 | 57.0 | 1.00 | 3.00 | 0 |
| Example 4 | 18.7 | 19.7 | 56.2 | 0.98 | 2.96 | 1.50 |

### Example 1

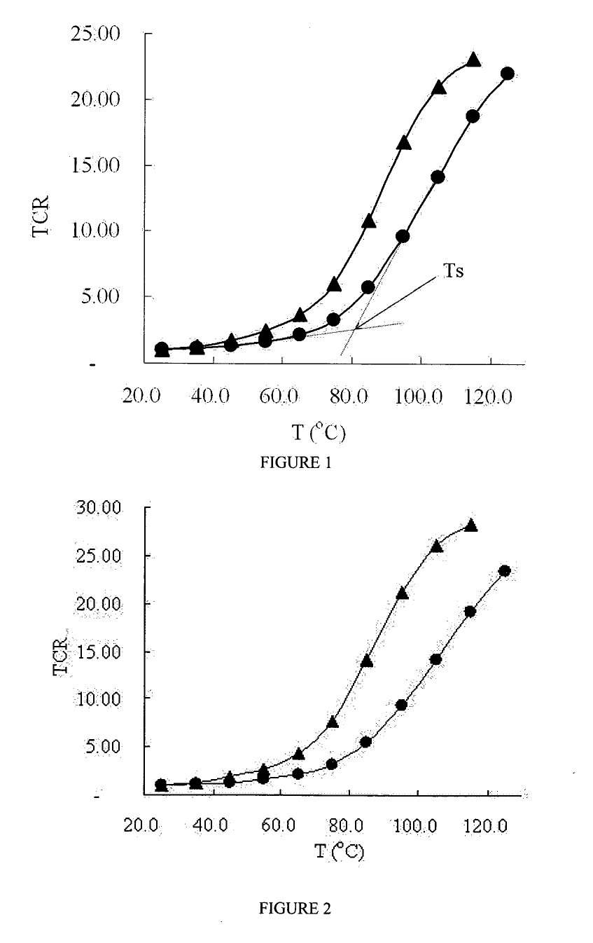

The PTC ink and film were made following the typical procedure described above. The polymer resin, carbon black, solvent, dispersing additive, and rheology additive used in this example are respectively ®Vinnolit PA 5470/5, MONARCH 120, dimethylnaphthalene, BYK-220S, and BYK-410, and their contents in the PTC compositions are listed in TABLE-1. The yielded resistivity at 25° C. of the PTC film from this example is 7.9 Kohm/sq. Referring to FIG. 1, the Ts of the PTC ink is at around 82° C., where the Ts is designated as the temperature at which extensions of the substantially straight potions of the plot of the TCR value against the temperature cross.

### Example 2

The same conditions were used as Example 1, but 1.0 wt. % Ts adjusting additive, PEG600 (Mₙ=600 g/mol), was added into the system. The resistivity at 25° C. of the PTC film from this example is 8.0 Kohm/sq. Referring to FIG. 1, the Ts of the PTC ink is at around 68° C. The only difference between Example 1 and Example 2 is the 1.0 wt. % Ts adjusting additive, which does not virtually alter the initial resistivity (7.9 Kohm/sq and 8.0 Kohm/sq, respectively, at 25° C.), but creates a big change of the Ts (82° C. and 68° C., respectively).

### Example 3

Example 3 was prepared in similar conditions as Example 1. Here, the carbon black used was REGAL 350R. The dispersing and rheology additive are respectively changed to ANTI-TERRA-204 and BYK-430. The resistivity at 25° C. of the PTC film of Example 3 is 4.2 Kohm/sq. Referring to FIG. 1, the Ts of the PTC ink is at around 85° C.

### Example 4

Example 4 was prepared in the same conditions as Example 3 except that 1.5 wt. % Ts adjusting additive, polyether (Mₙ=750 g/mol), was added into the system. The resistivity at 25° C. of the PTC film of Example 4 is 4.5 Kohm/sq. Referring to FIG. 2, the Ts of the PTC ink is at around 65° C. The difference between Example 3 and Example 4 is that the Example-4 containing 1.5 wt. % of Ts adjusting additive and the Example-3 containing no Ts adjusting agent, which brings on a small change of the starting resistivity (4.2 Kohm/sq and 4.5 Kohm/sq, respectively, at 25° C.), but a big change of the Ts (85° C. and 65° C., respectively).

What is claimed is:

1. A positive temperature coefficient (PTC) ink composition comprising, by weight, based on total composition: a) 10-50 wt. % polymer resin; b) 10-50 wt. % carbon black; c) 30-70 wt. % organic solvent, where the polymer resin and carbon black are dispersed in the organic solvent; d) at least 0.5-10 wt. % of Ts adjust agents and other optional additives.

2. The switching temperature (Ts) of the PTC ink of claim 1 can be adjusted by addition of the Ts adjusting agent and the Ts adjusting agent of claim 1 is chosen from polyester, polyether, and poly(ethylene glycol) with low molecular weight from 300 to 3000 g/mol.

3. The PTC ink of claim 1, further comprising 15-25 wt. % polymer resin. The PTC ink of claim 1, further comprising 15-25 wt. % carbon black.

4. The PTC ink of claim 1, further comprising 1.0-5.0 wt. % other optional additives and the other optional additives are dispersing agent, reeology modifier, and anti-setting agents.

5. The PTC ink of claim 1, wherein the polymer resin is chosen from chlorinated polyolefins containing carbonyl groups, or ester groups, or maleic anhydride groups.

6. A sheet of comprising a screen printing layer of a composition of claim 1 wherein the composition has been heated to remove volatile organic medium.

7. A sheet of claim 7 is used in self-regulated heating device.
